(19) United States
(12) Patent Application Publication
(10) Pub. No.: US 2005/0126699 A1
(43) Pub. Date: Jun. 16, 2005

(54) Process for the manufacture of composite structures

(76) Inventors: Anna Yen, Manhattan Beach, CA (US); James Winter Bohlen, Fountain Valley, CA (US)

Correspondence Address: LOUIS L. DACHS, 1794 PALISADES DRIVE, PACIFIC PALISADES, CA, 90272, US

(21) Appl. No.: 10/736,479

(22) Filed: Dec. 15, 2003

(51) Int. Cl. B29C 65/00

(52) U.S. Cl. 156/285

(57) ABSTRACT

The invention is a process for making a composite structure having a honeycomb core and face sheets using vacuum bagging techniques without the use of an autoclave. In detail, the process includes the following steps: 1) forming a preform sandwich assembly having previously de-bulked cover sheets impregnated with a fiber-reinforced resin having a first curing temperature, a honeycomb core and sheets of adhesive between the cover sheets and core, the first layer of adhesive having a second curing temperature less than the first curing temperature; 2) vacuum bagging the preform and drawing a vacuum; 3) initially heating the vacuum bagged preform at a heating rate of between 0.5 degree and 2 degrees per minute until the gel temperature of said adhesive is reached; 4) holding the temperature at the gel temperature until the layer of adhesive has cured; 5) raising the temperature to the first curing temperature of the fiber-reinforced resin; and 6) maintaining the temperature at the first curing temperature until the fiber-reinforced resin has cured.

### GOVERNMENT RIGHTS

This invention was made under National Aeronautics and Space Administration contract No.: NRA8-30, dated 2002. Therefore the United States Government retains the rights granted under this contract.

### BACKGROUND OF THE INVENTION

1. Field of the Invention

The invention relates to the field of composite structure fabrication procedures and, in particular, to a non-autoclave curing procedure for providing void free parts involving honeycomb sandwich.

2. Description of Related Art

There are numerous processes for making a honeycomb core composite structure. For example, previously cured cover sheets made up of layers of filamentary material in a resin matrix can be directly bonded by an adhesive to the honeycomb core. However, it is desirable to use pre-impregnated filamentary material as cover sheets and bond to the core as the resin in the cover sheets cure. To insure a good bond between the cover sheets and core, a layer of adhesive is placed therebetween.

The actual process involves laying up a preform of the core with face cover sheets on a tool surface or mold. The preform is vacuum bagged. A vacuum is drawn from within the bag, and the assembly is heated to the curing temperatures until the adhesive and resin are cured. Any trapped air or out- gassing from the resin and adhesive are drawn off because of the vacuum.

The bagged preform is heated to curing temperatures as the vacuum draws out any gases from the resin and/or adhesive. Alternately, the vacuum-bagged preform can be placed in an autoclave wherein the pressure applied to the preform for consolidation purposes can be increased above atmospheric pressure. This generally reduces the possibility of voids and provides a more uniform cover sheets. However, autoclaves are expensive.

Thus, it is a primary object of the invention to provide a process for producing high quality honeycomb sandwich structures.

It is another primary object of the invention to provide a process for producing honeycomb core structures without the use of an autoclave.

It is a further object of the invention to provide a process for producing honeycomb core structures without the use of an autoclave, but providing equal quality.

### SUMMARY OF THE INVENTION

The invention is a process for making a composite structure having a honeycomb core and face sheets using vacuum bagging techniques without the use of an autoclave. In detail, the process includes the following steps:
1. Separately de-bulking first and second covers made of multi-layers of filamentary material sheets pre-impregnated with a resin having a first curing temperature:
2. Forming a preform sandwich assembly by placing the first cover sheets on a mold surface; placing a first layer of adhesive on the first cover, the first layer of adhesive having a second curing temperature less than the first curing temperature of the first cover sheets; positioning a honeycomb core material over said first layer of adhesive; placing a second layer of adhesive on the honeycomb core; and placing the second cover on top of the second layer of adhesive core, said second layer of adhesive having a second curing temperature less than the first curing temperature for the cover sheets;
3. Vacuum bagging the assembly;
4. Drawing a vacuum from within said vacuum bag;
5. Initially heating the assembly at a heating rate of between 0.5±0.1 degree and 1.5±0.1 degrees Fahrenheit per minute until the gel temperature of said adhesive is reached;
6. Holding the temperature at the gel temperature until the layer of adhesive has 70% cured;
7. Raising the temperature to the first curing temperature of the fiber reinforced resin; and
8. Maintaining the temperature at the first curing temperature until the resin has cured.
   The above process is capable of forming composite sandwich structures having a quality equal to those fabricated by use of an autoclave. In addition, it does not require that the cover sheets be previously cured.

The novel features, which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF THE DRAWINGS

FIG. 1 is cross-sectional view of a completed composite structure comprising a honeycomb core and cover sheets made of filamentary material in a resin matrix made by the subject process.

FIG. 2 is a cross-sectional view of a tool use to de-bulk the fiber-reinforced cover sheets prior to curing.

FIG. 3 is a cross-sectional view of a typical vacuum bagging stack-up used for making the composite structures by the subject process.

FIG. 4 is a cross-sectional view of the apparatus shown in FIG. 3

### DESCRIPTION OF THE PREFERRED EMBODIMENT

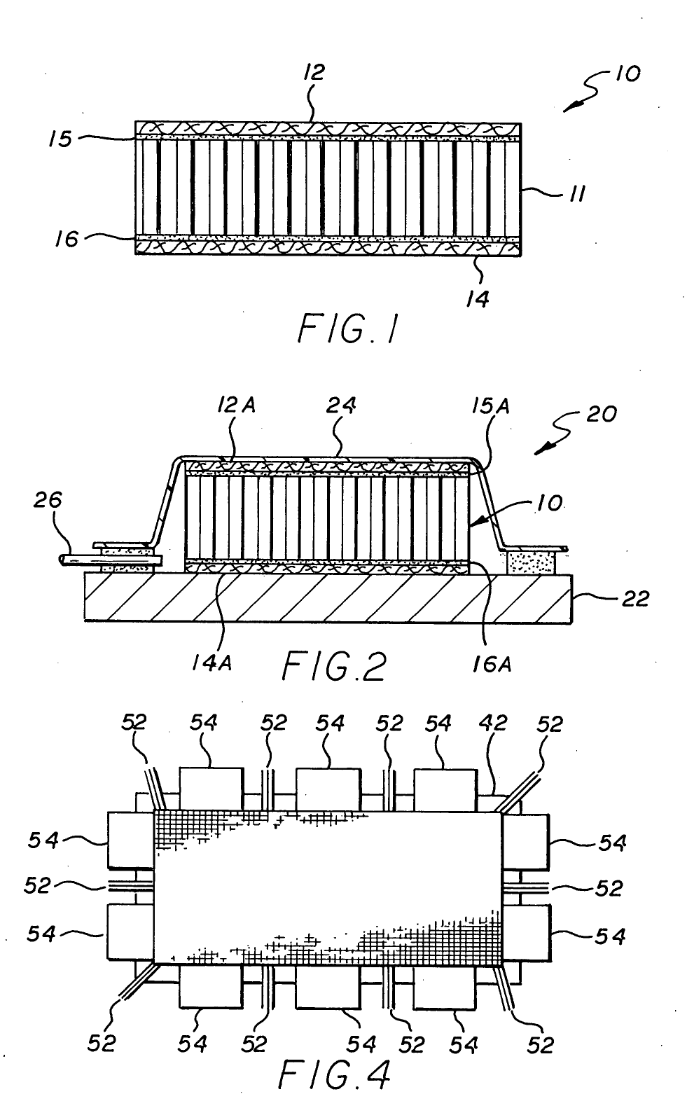

Referring to FIG. 1, the process is primarily used to make composite sandwich structures 10 comprising a honeycomb core 11, with cover sheets 12 and 14 made of layers of filamentary material in a pre-impregnated resin matrix bonded to the core by layers of adhesive 15 and 16, respectively. The filamentary layers can be made from unidirectional layers stacked at various angles such as 0, 45 and 90 degrees or a combination of angles. The composition of layers will depend upon the particular application. For handling purposes, the individual layers of filamentary are pre-impregnated with a resin and partially cured into pre-impregnated tapes. In this state, particularly if stored at low temperature, they have a significant shelf life. However, when assembled into a cover sheet, they must be de-bulked prior to curing of the resin to insure that the final structure is free of voids.

Thus, the individual plies or stacks of plies for the cover sheets, indicated by numerals 12A and 14A, prior to the curing process are individually de-bulked in the apparatus 20 shown in FIG. 2. For example, cover sheet 14A is place on a tool 22, covered with an impermeable cover 24, which is sealed to the tool sealing tape 26, typically chromate tape. A vacuum line 27 is provided so that a vacuum can be drawn. This will cause an entrapped air or gases to be withdrawn from the cover 14A. De-bulking process details will vary, but may include vacuum de-bulking of individual plies or stacks of plies, ultrasonic lamination, or warm or hot de-bulks.

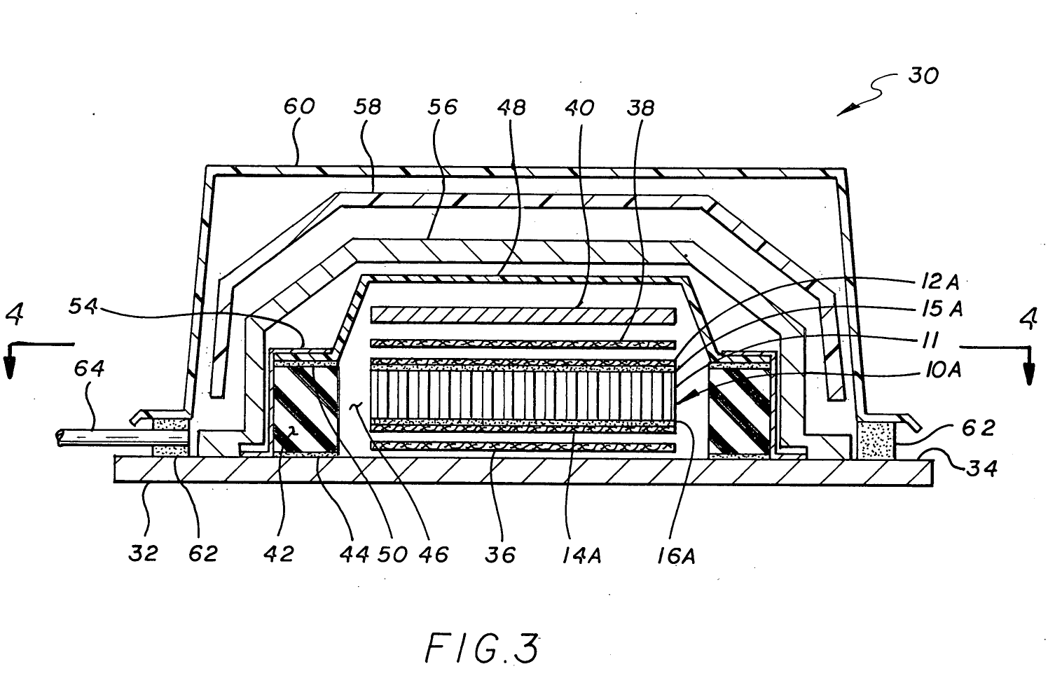

Referring now to FIGS. 3 and 4, the apparatus, generally indicated by numeral 30, includes a tool or mold 32 having a smooth surface 34. A layer of porous separator cloth 36, having a thickness of 0.005-inch, is placed on the surface 34. A suitable separator cloth 36 is Armalon, manufactured by the Richmond Company, Norwalk, California. The fiber-reinforced cover sheet 14A is placed over the cloth 36. An uncured sheet 16A of adhesive is placed over the cover sheet 14A; A honeycomb core 11 is then placed over the sheet 16A of adhesive. An uncured sheet 15A of adhesive is placed over the honeycomb core. The then the cover sheet 12A is placed over the sheet 15A of adhesive finally forming a composite sandwich structure preform 10A. A second sheet of separator cloth 38 is placed over the cover sheet 12A. An aluminum or cured composite caul plate 40, having a thickness of 0.25 inch is positioned there over.

Placed about the periphery of the preform 10A, is a silicone rubber dam 42 sealed to the surface 34 by double-sided tape 44. A suitable silicon rubber dam material is supplied by Airtech International Incorporated. A suitable tape 44 is manufactured by Fralock Company, Canoga Park, Calif. The gap 46 between the dam 42 and preform 10 should be less than 0.06 inch. A 0.001 or 0.003-inch thick non-porous sheet 48 of material is positioned over the caul plate 40 and preform 10A and sealed to dam 42 by a second layer of double sided tape 50. A suitable sheet 48 is A-4000 Non-porous Armalon manufactured by Airtech International Incorporated, Huntington Beach, Calif. However, fiberglass inserts 52 are positioned on top of the damn 42 creating flow paths there across. Strips of tape 54 are positioned between the fiber glass inserts 52 extend from the sheet 48 to the surface 34 of the tool 32, thus further securing the sheet 48 to the dam 42. A suitable fiberglass insert 52 is No.: 181-fiberglass 0.014 inch thick. A suitable tape 54 is 0.002 inch thick Flashbreaker Tape, manufactured by Airtech International Incorporated.

Positioned over the sheet 48 and dam 42 is a layer or layers 56 of fiberglass breather cloth (0.014 inch per ply). For example, 2-181 fiberglass manufactured by Richmond Company. A sheet 58 of 0.126-inch thick polyester material is positioned over the layers 56. Finally, a vacuum bag 60 is positioned over the sheet 58 and sealed to the surface 34 by means of vacuum bag sealed tape 62. Preferably the vacuum bag material is 0.003-inch thick nylon material obtainable from Airtech International Incorporated. The tape 62 is GS 100 also manufactured by Airtech International Incorporated. Vacuum port lines 64 extend to the tape 62 and are coupled to vacuum pumps (not shown). These sheets are needed to make an air tight vacuum bag without leaving impressions called “mark-offs” in the composites. The lower sheets are used to contain the resin of the prepreg resin flow is restricted to within the sheets. The dams prevent the edges from being pinched off, crushed or made thinner than the surrounding materials. The completed assembly is typical of that used to make composite structures and there are variations both as to the selection of materials, thickness thereof and the sources.

With the assembly illustrated in FIG. 3 and 4, is then place in an oven and the following cure cycle is followed.
1. A vacuum is drawn through the ports 64, which causes the vacuum bag 60 to contract about compressing the sheets 48, 56, 58 about the caul plate 40 and preform 10A. The vacuum level should be at least 25 inches of mercury.
2. The temperature is slowly raised at a rate of 0.5 to 2 degrees per minute; preferably 1 degree per minute until an intermediate temperature is reached and held to provide approximately 70 percent cure of the sheets 15A and 16A of adhesive.
3. The intermediate temperature is maintained for a period of approximately one-hour or until the sheets 15A or 16A have reached the gel state. This minimizes the formation of bubbles in the sheets of adhesive.
4. The temperature is then raised to and held for the appropriate time at the curing temperature of the first resin in the fiber-reinforced cover sheets 14A and 14B until the sheets have cured. At this point the preform 10A had been transformed into the completed composite sandwich structure 10.
   Thereafter, the assembly is removed from the oven, and after the assembly has cooled sufficiently, the composite structure 10 can be removed from the tool.

Numerous structures have been fabricated using this procedure. For example:
1. Cover 12 and 14 sheets made 8 to 128 layers of layers of Part no. IM7/977-2 epoxy pre-impregnated graphite fibers manufactured by Cytec Corporation, Anaheim.
2. Kevlar® paper honeycomb core 11, Part HK362-04896 manufactured by M. C. Gill Company, El Monte, Calif.
3. Sheets 15 and 16 of adhesive were EA9696AL manufactured by Loctite, Bay Point, Calif.
   The process has produced structures equal in quality to autoclave produced structures wherein the cover sheets were pre-consolidated and cured.

While the invention has been described with reference to a particular embodiment, it should be understood that the embodiment is merely illustrative, as there are numerous variations and modifications, which may be made by those skilled in the art. Thus, the invention is to be construed as being limited only by the spirit and scope of the appended claims.

### INDUSTRIAL APPLICABILITY

The invention has applicability to any industry using composite structures, in particular aircraft manufacturing industries.

1. A process for making composite parts comprising:
separately de-bulking first and second covers made of multi-layers of sheets filamentary material sheets pre-impregnated with a resin having a first curing temperature;
forming a preform sandwich assembly by:
placing the first cover on a mold surface;
placing a first layer of adhesive on the first cover, said first layer of adhesive, said first layer of adhesive having a second curing temperature less than the first curing temperature;
positioning a honeycomb core material over said first layer of adhesive;
placing a second layer of adhesive on the honeycomb core; and
placing the second cover on top of the second layer of adhesive core, said second layer of adhesive having a second curing temperature less than the first curing temperature;
vacuum bagging the assembly;
drawing a vacuum from within said vacuum bag;
initially heating the assembly at a heating rate of between 0.5 degree and 2 degrees per minute until the gel temperature of said adhesive is reached;
holding the temperature at the gel temperature until the layer of adhesive has cured;
raising the temperature to the first curing temperature of the resin; and
maintaining the temperature at the first curing temperature until the resin has cured.

2. The process of claim 1 where in the step of drawing a vacuum from within said vacuum bag the vacuum is a minimum of 25 inches of Hg.

3. The process as set forth in claim 2 wherein the resin in the first curing temperature is 350° F.

4. The process as set forth in claim 3 wherein in said step of the initially heating the assembly at a heating rate of between 0.5 degree and 2 degrees per minute until the gel temperature of said adhesive is reached, the rate of heating is 1 degree per minute.

5. The process as set forth in claim 4 wherein prior to the step vacuum bagging the assembly, the steps:
forming a resin containment dam about the preform;
providing a path through dam such that a vacuum can be drawn from within the containment dam.

6. The process as set forth in claim 5 wherein the distance from the dam to the preform is a maximum of 0.06 inch.
